(19) United States
(12) Patent Application Publication
(10) Pub. No.: US 2025/0067123 A1
(43) Pub. Date: Feb. 27, 2025

(54) LADDER LEVELING MECHANISM

(71) Applicant: Werner Co., Greenville, PA (US)

(72) Inventor: Michael Scheurich, Gilberts, IL (US)

(21) Appl. No.: 18/812,286

(22) Filed: Aug. 22, 2024

Related U.S. Application Data
(60) Provisional application No. 63/534,252, filed on Aug. 23, 2023.
(60) Provisional application No. 63/605,104, filed on Dec. 1, 2023.

(51) Int. Cl. E06C 7/44; E06C 1/06

(52) U.S. Cl. CPC E06C 7/44; E06C 1/06

(57) ABSTRACT

A leveler attachment including a first leg assembly and a second leg assembly, the first leg assembly and the second leg assembly each including a lever, a shaft movable by adjustment of the lever, a locking mechanism coupled to an end of the shaft, the locking mechanism including a gear lock, a rotatable gear, and a rack to interact with teeth of the rotatable gear. The rotatable gear is configured to rotate on the rack when in an unlocked state causing inverse motion of the first leg assembly relative to the second leg assembly. Adjusting the locking mechanism to the unlocked state includes lifting the lever which lowers the shaft and disengages the teeth of the rotatable gear from the gear lock thereby permitting the rotatable gear to rotate along the rack.

### CROSS-REFERENCE TO RELATED APPLICATION(S)

The present application claims priority to U.S. Provisional Application No. 63/534,252, filed Aug. 23, 2023 and U.S. Provisional Application No. 63/605,104 filed Dec. 1, 2023 both of which are incorporated by reference herein in their entirety.

### TECHNICAL FIELD

The present disclosure relates to a leveling mechanism for climbing apparatus such as ladders, stools, and work platforms, which may assist in leveling the same on uneven ground.

### BACKGROUND

Climbing apparatus, such as ladders, stools, and work platforms, typically provide access to elevated locations and/or items therein, and may be used in a variety of locations. Depending on the location and/or typical operating conditions in those locations, one or more features or accessories may be utilized with the ladder to improve stability and/or usability. Indeed, in some of these locations, features may be incorporated into or accessories may be attached to a ladder to assist or help the user by customizing the ladder for a particular task or location.

Previously, a user may have employed a variety of ladder leveling accessories, such as hand cranks, rachet systems, or bulky attachments, to help manage risks associated with use of the ladder on uneven surfaces. These accessories, however, may be difficult to use, or put a high level of mechanical stress on small elements of these mechanisms.

### BRIEF DESCRIPTION OF THE DRAWINGS

Disclosed herein are embodiments of assemblies and apparatuses pertaining to providing a ladder leveling mechanism. This description includes drawings, wherein:

FIG. 1 is a perspective view of a leveler mechanism or attachment coupled to a ladder in accordance with various embodiments;

FIG. 2 is a perspective view of a leveler attachment coupled to a ladder in accordance with various embodiments;

FIG. 3 is a front perspective view of a leveler attachment coupled to a portion of a ladder in accordance with various embodiments;

FIG. 4 is a rear perspective view of a leveler attachment coupled to a portion of a ladder in accordance with various embodiments;

FIG. 5 is a front partial perspective view of a lever of a leveler attachment coupled to a portion of a ladder in accordance with various embodiments;

FIG. 6 is a side perspective view of a leveler attachment coupled to a portion of a ladder in accordance with various embodiments;

FIG. 7 is a side perspective view of a leveler attachment coupled to a portion of a ladder in accordance with various embodiments;

FIG. 8 is a rear partial perspective view of a portion of a locking mechanism of a leveler attachment coupled to a ladder in accordance with various embodiments;

FIG. 9 is a side perspective view of a portion of a locking mechanism of a leveler attachment coupled to a ladder in accordance with various embodiments;

FIG. 10 is a side perspective view of a portion of a locking mechanism of a leveler attachment coupled to a ladder in accordance with various embodiments;

FIG. 11 is a side perspective view of a portion of a locking mechanism of a leveler attachment coupled to a ladder in accordance with various embodiments;

FIG. 12 is a side perspective view of a portion of a locking mechanism of a leveler attachment coupled to a ladder in accordance with various embodiments;

FIG. 13 is a side perspective view of a portion of a locking mechanism of a leveler attachment coupled to a ladder in accordance with various embodiments;

FIG. 14A is a side perspective view of a portion of a locking mechanism of a leveler attachment coupled to a ladder in accordance with various embodiments;

FIG. 14B is a side perspective view of a portion of a locking mechanism of a leveler attachment coupled to a ladder in accordance with various embodiments;

FIG. 15A is a perspective view of a leveling attachment in accordance with various embodiments;

FIG. 15B is a rear perspective view of a leveler in accordance with various embodiments;

FIG. 16 is a side perspective view of a portion of a locking mechanism of a leveler attachment in accordance with various embodiments;

FIG. 17A is an exploded view of a component of a locking mechanism of a leveler attachment in accordance with various embodiments;

FIG. 17B is an exploded view of a component of a locking mechanism of a leveler attachment in accordance with various embodiments;

FIG. 18 is a side perspective view of a portion of a locking mechanism of a leveler attachment in accordance with various embodiments;

FIG. 19 is a side perspective view of a portion of a locking mechanism of a leveler attachment in accordance with various embodiments;

FIG. 20 is a side perspective view of a portion of a locking mechanism of a leveler attachment in accordance with various embodiments;

FIG. 21 is a perspective view of a portion of a leveler attachment in accordance with various embodiments; and

FIG. 22 is a perspective view of a leveling system in accordance with various embodiments.

FIG. 23 is a perspective view of a leveling system in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

The present disclosure relates to ladders and one or more ladder accessories for use therewith, such as ladder leveling mechanisms and assemblies. The ladder accessories, such as leg assemblies, leveling mechanisms, and/or adjustment mechanisms, described herein, are typically used to help users level the ladder on uneven ground, and in turn, manage potential risks associates with use of the ladders on uneven ground. For example, when a user places a ladder down on uneven ground, the leveling mechanisms may be used with the ladder to assist with leveling the ladder, and consequentially, the management of potential risks associated therewith, such as the risk of falls. In this way, a standard ladder including the leveling mechanisms, or a ladder having the leveling mechanisms, can be used on varying uneven surfaces allowing for many different tasks and/or locations for the ladder.

By some approaches, the ladder mechanisms described herein may be easily attached and manipulated such that a user may quickly and easily associate the ladder leveling mechanisms with the ladder for use therewith. Further, such manipulation of the ladder is typically performed with little or no damage or stress on the ladder.

In one configuration, the ladder leveler includes a first leg assembly and a second leg assembly. The leg assemblies may each include a lever, a shaft movable by adjustment of the lever, and a locking mechanism coupled to an end of the shaft. In some approaches, the locking mechanism includes a gear lock, a rotatable gear, and a rack to interact with teeth of the rotatable gear. In some configurations, the leg assemblies also may include a connecting rod coupling the first leg assembly and the second leg assembly.

By some approaches, the connecting rod is configured to extend through a rung of the ladder, and configured to rotate the rotatable gear on the rack when in an unlocked state causing inverse motion of the first leg assembly relative the second leg assembly. In this way, adjusting the locking mechanism to the unlocked state includes lifting the lever to dispose it generally orthogonal to a first rail and a second rail of the ladder, which lowers the shaft and disengages the teeth of the rotatable gear from the gear lock thereby permitting the rotatable gear to rotate along the rack, and adjusting the locking mechanism to a locked state includes lowering the lever which raises or engages the shaft and the teeth of the rotatable gear onto the gear lock inhibiting the rotatable gear from rotating on the rack.

By yet further approaches, leveler attachments may be integrated with an existing, pre-formed, or previously manufactured ladders including those lacking significant leveling features. Further, the leveler attachments described herein also may be retrofit onto previously used ladders. In this way, a user may couple the leveler attachments to at least one portion of a ladder, such as e.g., a rung of an existing pre-formed ladder to add leveling capabilities thereto. The existing ladder may be, for example, an extension ladder, a step-ladder, a multi-position ladder, or a platform ladder. In some configurations the leveler attachments may be added to work platforms and the like to provide substantial leveling capabilities.

In one approach, the lower portion or feet of the existing pre-formed ladders may be removed to facilitate coupling of the leveling mechanism. For example, the feet pay be removed, the leveler attachments added to the existing climbing structure, and the feet of the existing climbing structure placed onto or secured to the end of the ladder leveler attachment. While the discussion herein may focus on a ladder, and in particular an extension ladder, the present disclosure contemplates the application of the leveling attachments and assemblies to be applied to a variety of climbing apparatus such as, e.g., step-ladders, multi-position ladders, platform ladders, and work platforms.

The ladders, components, and/or accessories described herein may be formed of a variety of materials and using a variety of manufacturing techniques. Such materials may include, e.g., metals, plastics and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as aluminum or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of metal materials such as magnesium, magnesium alloys, aluminum, or aluminum alloys. The rungs may be manufactured, for example, via an extrusion process and cut to length. The rungs may take a variety of shapes and may be, for example, rounded, D-shaped, or triangular. Further, the rungs may have a hollow or substantially hollow cross-section.

The rungs of a ladder may be attached to the rails in a variety of different manners. In one approach, the rungs and rails are forged together, such as by having the rungs being attached to the rails via a direct swage connection. In a direct swage connection, a rung is attached directly to the rails using a cold forming process, where a moving die shapes the rung around a hole that was pre-punched in the rail. Annealing operations may be used to soften the metal to prevent cracking. In other approaches, the rungs are attached to the rails via a rung-plate connection in addition to other attachment types. In a rung-plate connection, a rung is attached to a plate and the plate is attached to the rail via one or more rivets or other mechanical elements.

Other portions, accessories, and/or assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, steel, or sheet metal. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee caps may be riveted to the ladder.

Generally speaking, pursuant to these various embodiments and systems described herein which may be used to provide a leveling mechanism or attachment for a ladder which may be incorporated with or coupled to a ladder, such as an extension ladder. In one illustrative approach, a leveler mechanism or attachment includes a pair of leg assemblies, each having a lever to lock and unlock a locking mechanism. The leg assemblies may include a connecting rod coupling the leg assemblies together and resulting in inverse motion of the leg assemblies.

In some embodiments, a ladder leveler system includes a first leg assembly and a second leg assembly. Each leg assembly includes a lever, a shaft moveable by adjustment of the lever, and a locking mechanism coupled to an end of the shaft. The locking mechanism includes a gear lock, a rotatable gear, and a rack to interact with teeth of the rotatable gear. The leveler may further include a connecting rod coupling the first leg assembly and the second leg assembly. By some approaches, the connecting rod is configured to extend through a rung of the ladder and configured to rotate the rotatable gear on the rack when in an unlocked state causing inverse motion of the first leg assembly relative the second leg assembly. Further, adjusting the locking mechanism to the unlocked state includes lifting the lever to dispose it generally orthogonal to a first rail and a second rail of the ladder, which lowers the shaft and disengages the teeth of the rotatable gear from the gear lock thereby permitting the rotatable gear to rotate along the rack, and adjusting the locking mechanism to a locked state includes lowering the lever which raises the shaft and the teeth of the rotatable gear onto the gear lock inhibiting the rotatable gear from rotating on the rack.

The present disclosure relates to a leveling assembly including a first rail, a second rail, a plurality of rungs spaced between the first rail and the second rail, and a pair of leg assemblies. In one illustrative approach, the leg assemblies include a first leg assembly and a second leg assembly, where the first leg assembly and the second leg assembly each include a lever, a shaft movable via adjustment of the lever, and a locking mechanism including a gear lock, a rotatable gear, and a rack to engage with teeth of the rotatable gear. The leveling assembly further may include a housing substantially enclosing the first leg assembly and the second leg assembly including at least one opening and a securement mechanism.

In some configurations, the securement mechanism is configured to attach the first leg assembly to the first rail of the ladder and to attach the second leg assembly to the second rail of the ladder. Additionally, a connecting rod coupling the first leg assembly and the second leg assembly may extend through the at least one opening in the housing and at least one of the plurality of rungs. In this manner, the connecting rod is configured to rotate the rotatable gear on the rack when in an unlocked state or lifted state causing inverse motion of the first leg assembly relative the second leg assembly. In leveling the ladder on an uneven surface, the ladder is lifted which and allows a weight of at least one of the ladder or the first leg assembly and the second leg assembly to provide an initial leveling of the ladder, and/or raising the lever to the unlocked state which raises the gear lock from the teeth of the rotatable gear, permitting movement of the rotatable gear on the rack.

In some embodiments, the present disclosure relates to a ladder including a first rail, a second rail, a plurality of rungs spaced between the first rail and the second rail, a first leg coupled to the first rail, a second leg coupled to the second rail, and a pair of leveling mechanisms, where the pair of leveling mechanisms includes a locking mechanism comprising a gear lock, a shaft coupled to the gear lock, and a lever coupled to the shaft, and the pair of leveling mechanisms further includes a rotatable gear and a rack coupled to a housing of the pair of leveling mechanisms, wherein the pair of leveling mechanisms are coupled together such that movement of the gear on the rack results in movement of the first leg and the second leg.

In yet further embodiments, the present disclosure relates to a ladder including a first rail, a second rail, a plurality of rungs spaced between the first rail and the second rail, a macro-leveling adjustment mechanism, and a micro-leveling adjustment mechanism, where the macro-leveling adjustment mechanism levels the ladder utilizing a weight of the ladder and a surface the ladder is placed upon, and where the micro-leveling adjustment mechanism levels the ladder after the macro-leveling adjustment mechanism and utilizes a lever to unlock a rack and pinion to adjust the first rail and the second rail.

By some approaches, the leveling assembly provides for fine adjustment leveling of a ladder on uneven surfaces. A first leveling may occur when a substantial portion of a weight of the ladder, or a portion of a work platform, is lifted in a substantially vertical direction. In doing so, a locking mechanism is unlocked, allowing for the legs assemblies, the legs and/or feet in particular, to extend out of the leveling assemblies. A connecting rod extending between the leveling assemblies produces inverse motion of the leg assemblies due to the leg assemblies being directly connected by the connecting rod. Once both leg assemblies are contacting the ground, the ladder may be substantially level. To provide additional fine leveling, a second leveling may occur using a lever to unlock the locking mechanism. When the lever is moved, the locking mechanism may unlock and the ladder can be tilted about the base to provide an additional fine leveling of the ladder.

In one example implementation, a user may lift the ladder or work platform while on the uneven ground. In such an implementation, by lifting the weight of the ladder or work platform, a spring included in the locking mechanism biases a gear included in the locking mechanism away from a gear lock via a bracket. When the gear is moved out of the gear lock, the gear is permitted to rotate on a rack coupled to the leg assemblies. In this way, the leg assemblies are able to move out of the leveling assemblies and contact the ground. In such a configuration, because the leg assemblies are directly coupled together via a connecting rod, the inverse motion created therewith allows for a first leveling of the ladder.

In some configurations, the first leveling step is limited by the angle, such as the tilt, at which the ladder is held. If the ladder is lifted and held at an angle, the resulting first leveling may be off-level and tilted. Due to the weight of the ladder, this may occur with some frequency. Providing a second fine leveling step alleviates this. Once the first leveling is completed and the weight of the ladder is resting on the ground, a second leveling can occur. This second leveling provides for a more fine-tuned leveling of the ladder. In this way, a lever is moved, the movement of the lever moves a bracket which overcomes a spring force and biases the gear out of the gear lock, unlocking the leveling assemblies. Once unlocked, the ladder can be tilted side to side to finish leveling the ladder. The levers may then be returned to the first position and the ladder can be used.

The second leveling allows for not just fine leveling, the second leveling allows for multiple different occurrences of leveling the ladder while the ladder is on the uneven surface. As ladders are used on many different surfaces, some of these surfaces may be, for example, soft, unpacked/hardened, or wet. When a user climbs the ladder, portions of the ladder, and in particular the feet of the ladder, may settle or dig into the ground. In use, if only the first leveling operation is employed, the user would need to lift the ladder out of the ground, move the ladder slightly to avoid the spots where the feet dug in, and readjust the ladder to level it once again. This would likely include moving the ladder a few inches away from the first location. The second leveling, however, allows for the ladder to remain in place and titled to account for the settling of the feet of the ladder into the ground.

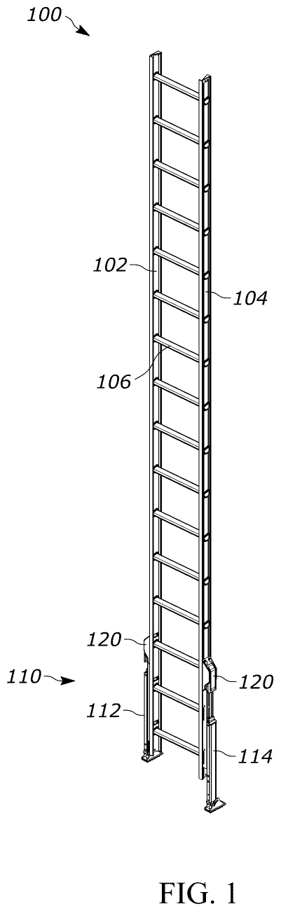

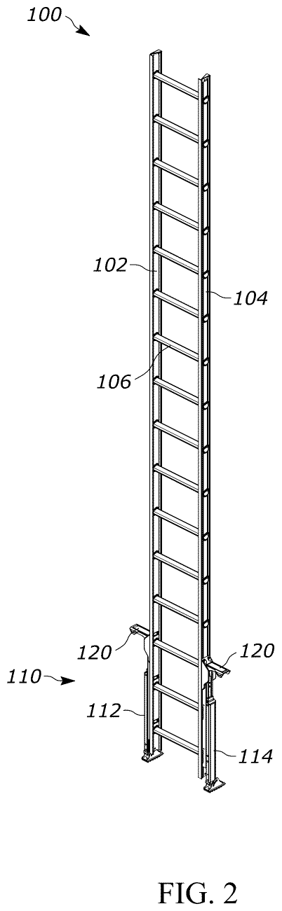

Referring to the drawings wherein like reference numerals refer to similar or identical parts throughout the several views, and in particular FIGS. 1 and 2, illustrates a ladder 100. The ladder 100 includes a first rail 102, a second rail 104, and a plurality of rungs 106. The first rail 102 and the second rail 104 are in a spaced and substantially parallel relationship. The plurality of rungs 106 extend between the first rail 102 and the second rail 104, coupling the first rail 102 and the second rail 104 to one another. The ladder 100 further includes ladder leveling assemblies, attachments, or system 110. The leveling system 110 includes the first leveling mechanism or first leveler 112 and the second leveling mechanism or second leveler 114. The first leveler 112 and the second leveler 112 of the leveling system 110 are coupled to each rail, 102 and 104, of the ladder 100. Each leveler, 112 and 114, includes a handle or lever 120. As shown in FIG. 1, the levers 120 are in a downward or closed position. Conversely, as shown in FIG. 2, the levers 120 are in an upward or open position.

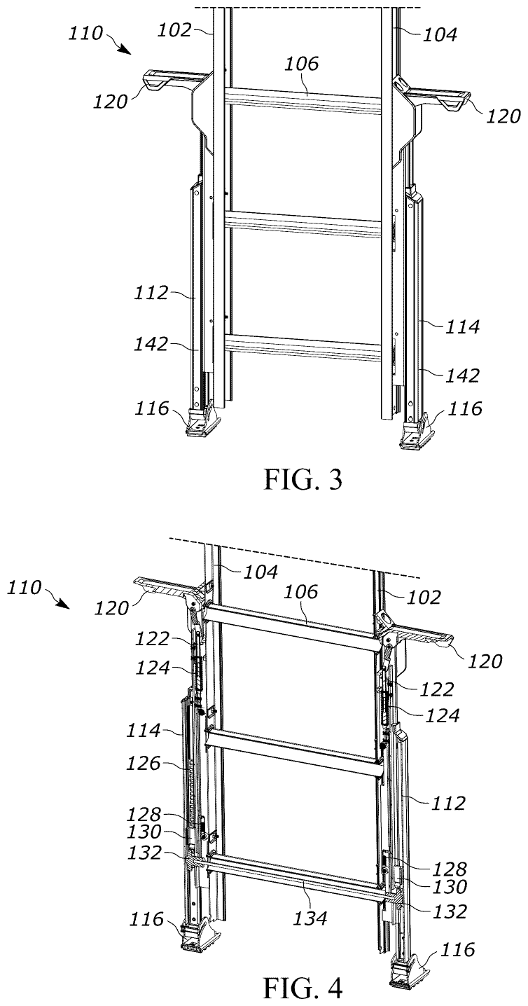

As shown in FIG. 3, the leveling system 110 typically includes the first and second leveler 112, 114, which have a lever 120, feet 116, and a housing 142. Turning now to FIG. 4, the leveling system 110 also may include a first or safety spring 124, a rack 126, a second or stability spring 128, a gear lock 130, a gear 132, and a shaft 122 or similar mechanisms. Once installed, the first leveler 112 and the second leveler 114 are coupled together via a connecting rod 134 (see FIG. 4). The shaft 122 is coupled to the lever 120 at a top end of the shaft 122 and the spring 128 at a bottom end of the shaft 122, and in some embodiments, the shaft 122 is coupled to the spring 124 near the top end, or an intermediate portion, of the shaft 122.

By some approaches, the rack 126 is coupled to an inside surface of the housing 142. In such a configuration, the rack 126 is further connected to the feet 116 such that movement of the rack 126 results in movement of the feet 116. The gear lock 130 also is typically coupled to the inside portion of the housing 142. In some embodiments, the spring 128 also includes a bracket. The bracket, through movement of the spring 128, may contact the gear 132. The rack 126 may vary in length. Generally, the length of the rack 126 corresponds to an approximate maximum leveling of the ladder 100. In one illustrative example, the rack 126 is about 8.5 inches in length. In this embodiment, the initial leveling can level the ladder 100, and in particular the leveling system 110, up to 8.5 inches. Similarly, the fine-tuned second leveling can lever the ladder 100, and in particular the leveling system 110, up to 8.5 inches.

FIG. 4 illustrates a cross-sectional view of the leveling system 110, and in particular the first leveler 112 and the second leveler 114. The rack 126 is shown disposed within the housing 142 in the second leveler 114. The rack 126 is not shown on the first leveler 112 because the rack 126 of the first leveler 112 is disposed on the opposite side compared to the rack 126 of the second leveler 114. That is to say, the first leveler 112 and the second leveler 114 are the same leveler rotated 180 degrees about a vertical axis, resulting in the rack 126, and the other elements disposed therein and thereon, to be on opposite sides of one another. In this way, the leveling system 110 may be produced cheaper by producing a single leveler, as opposed to two different levelers, one for each side, which can be sold and used as a pair.

The housing 142 may at least partially enclose or encapsulate portions of the leveling system 110. The housing 142 may include one or more openings therein for the connecting rod 134 to extend between at least one of the plurality of rungs 106 and allow the leveling system 110 to attach to the rails using the securement mechanism 138. The housing 142 may be formed out of various materials, such as aluminum, steel, plastic, FRP, or carbon fiber. The securement mechanism 138 may comprise at least one set of bolts to attach or couple the portions of the leveling system 110 to the rails, 102 and 104.

In some configurations, the gear 132 is coupled to the inside of the housing 142. The gear assembly includes a stationary portion for coupling to the housing 142 and a rotatable portion such that the gear 132 may rotate. The gear 132 may include varying number of teeth and associated gaps between the teeth. In one embodiment, the gear 132 includes twelve (12) teeth and associated gaps. The number of teeth and associated gaps therebetween correlate to the locking positions such that a greater number of teeth there are on the gear 132 the greater number of locking positions. In operation, the teeth of the gear 132 interact with the rack 126 to move the associated feet 116. Each gear 132 of the first leveler 112 and the second leveler 114 are coupled together via the connecting rod 134. In some embodiments, the connecting rod 134 includes a substantially square or rectangular cross-section. In some embodiments, the connecting rod 134 has a substantially circular, hexagonal, spline, or ovular cross-section.

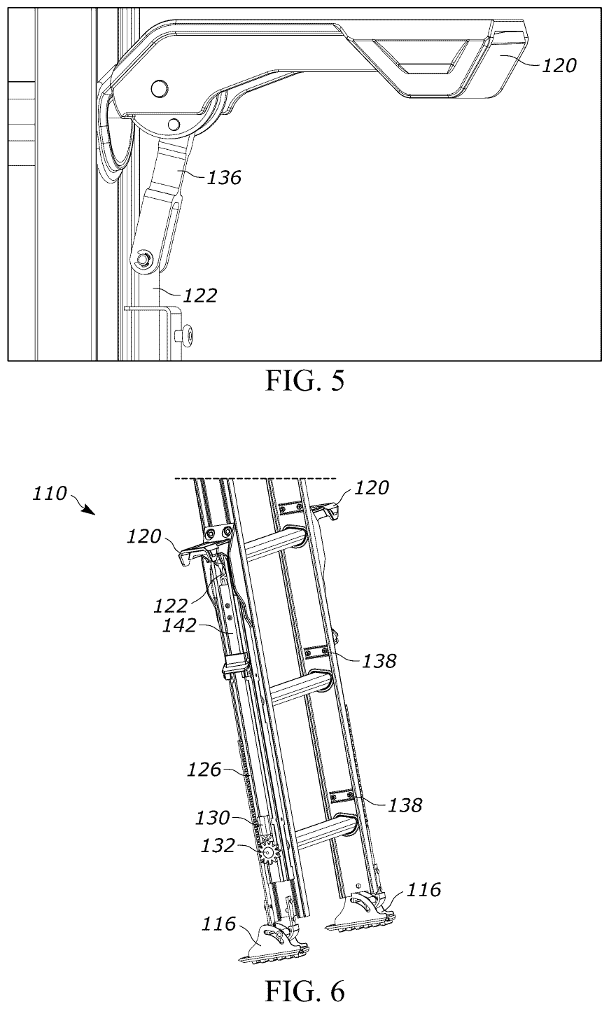

Referring to FIG. 5, the lever 120 as shown, includes linkage 136 coupling the lever 120 to the shaft 122. In some configurations, the lever 120 includes an over-center design. This design results in the lever 120 being held in position, either open or closed, from the spring 124. The over-center design, via the linkage 136, creates a downward movement of the shaft 122 when the lever 120 is moved from the closed position and into the open position. Conversely, an upward movement is created when the lever 120 is moved from the open position to the closed position. While the movement generated by lifting the lever 120 has been described as the shaft 122 moving downward when moved to an open position, the present disclosure contemplates an upward movement of the shaft 122 when the lever 120 is moved to the open position. In some embodiments, the opened position may be generally orthogonal to the first rail 102 or the second rail 104. In other configurations, the movement of the shaft 122 may be aligned with the lever 120 such that the downward movement of the lever 120 results in a downward movement of the shaft 122.

In some embodiments, the lever 120 may be on one rail only and provide an unlocking of a locking mechanism 140, described in more detail below. In some embodiments, the lever 120 may include a dead-man's switch such as a button or other actuatable element, to keep the lever 120 in an opened position. If the dead-man's switch was released, the lever 120 would close and lock the locking mechanism 140. In doing so, the dead-man's switch provides a safety measure to lock the locking mechanism 140 when the dead-man's switch is released such that the locking mechanism 140 is locked and the ladder 100 can be used. In yet further embodiments, the dead-man's switch may include a biasing mechanism that biases the lever 120 closed such that a user must hold the lever 120 open while leveling. In this way, if a user were to release the lever 120, the lever 120 would close and lock the locking mechanism 140.

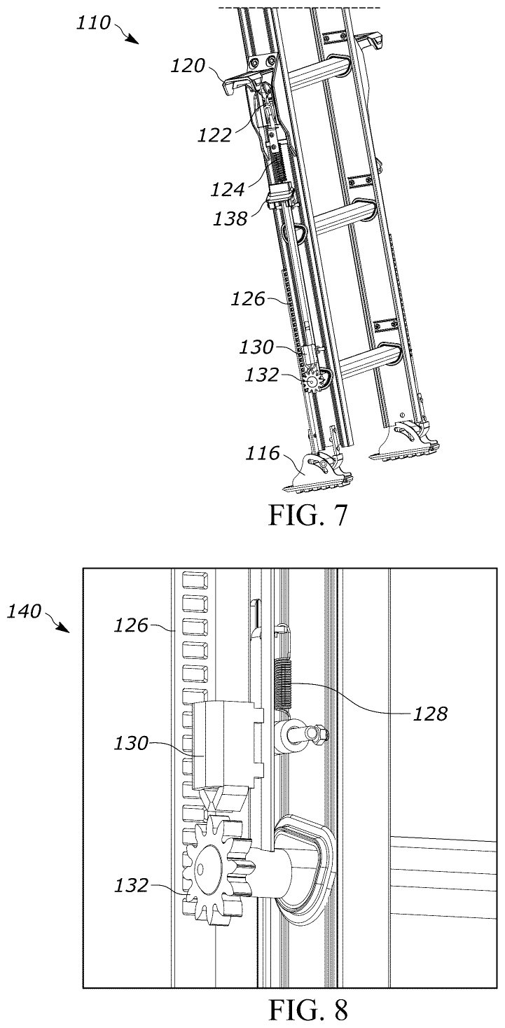

Referring to FIG. 6, the leveling system 110 is shown with a portion of the housing 142 removed, specifically with a lower portion of the housing 142 is removed. The housing 142 includes attachment points, such as openings, for securement mechanisms 138. The securement mechanism 138 may include a plurality of different bolts and brackets to secure the leveling system 110 onto the rails 102 and 104. The securement mechanism 138 allows the leveling system 110 to be affixed to existing ladders and potentially avoids the need for a user to purchase a separate, additional, ladder that includes a leveling system 110. FIG. 6 and FIG. 7 further illustrate the gear 132 interacting with the rack 126. The teeth and spaces of the gear 132 are sized to fit into the rack 126. The spring 124 is coupled to the shaft 122 at the intermediate portion, near the top of the shaft 122.

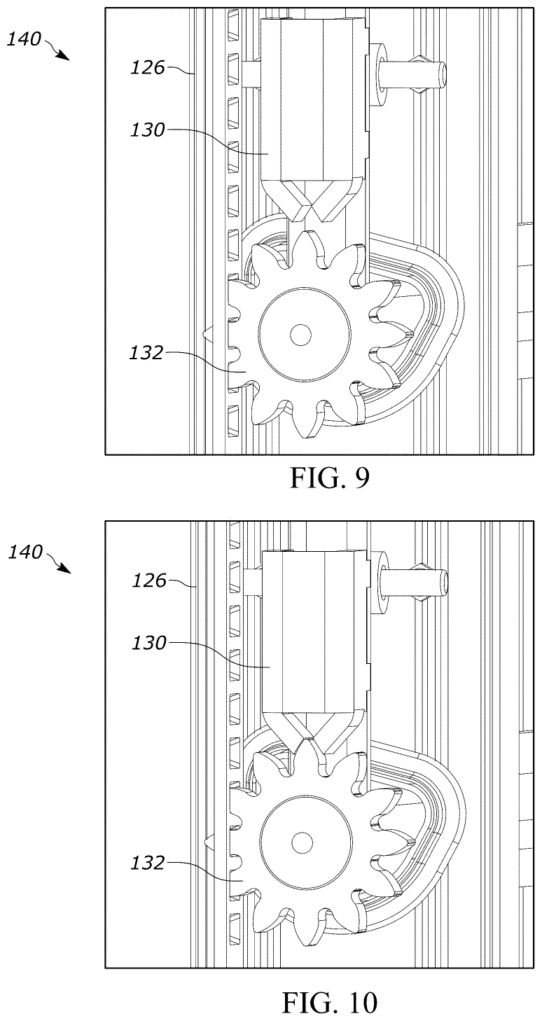

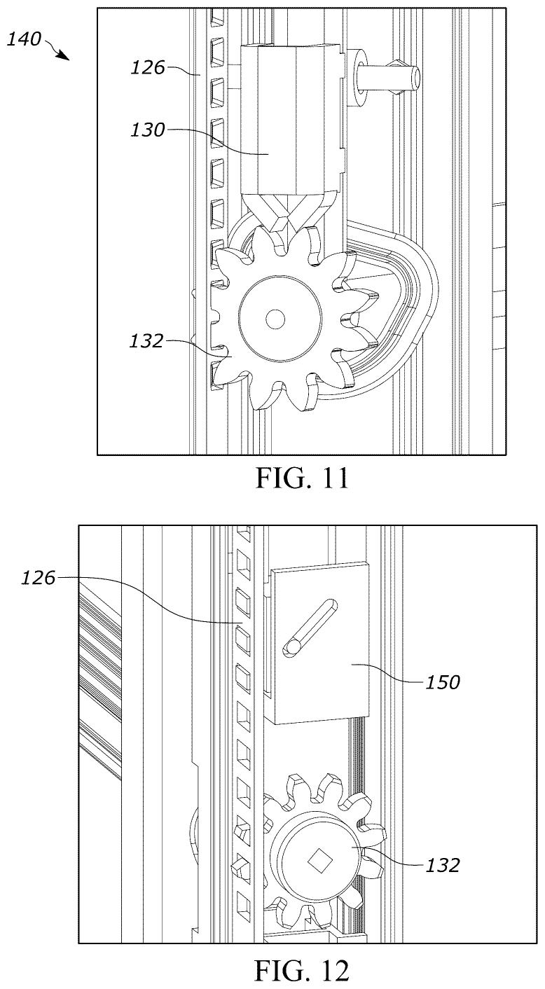

FIGS. 8 and 9 illustrate a locking mechanism 140 of the leveling system 110 in an unlocked position. This is illustrated by the gear lock 130 not being in contact with the gear 132. When in the unlocked position, the gear 132 is permitted to rotate on the rack 126. Conversely, as shown in FIGS. 10 and 11, the locking mechanism 140 of the leveling system 110 are in a secured or locked position. This is illustrated by the gear lock 130 being in contact with the gear 132, either contacting the teeth of the gear 132 or a space between the teeth of the gear 132. The locking mechanism 140 includes at least the rack 126, the spring 128, the gear lock 130, and the gear 132.

In use, a first leveling occurs by the ladder 100 being lifted, and in particular, a substantial portion of a weight of the ladder 100 being lifted. Due to the reduced weight of the ladder 100 on the spring 128, the spring 128 expands. The spring 128 is coupled to a bracket which is biased downward and contacts the gear 132. The gear 132 is biased downward from the gear lock 130, unlocking portions of the leveling system 110. This may be considered the first unlocked state. In the first unlocked state, by the user lifting the ladder, the gear 132 is permitted to rotate on the rack 126. The rotation of the gear 132 on the rack 126 results in the feet 116 being extended out of the end of the leveler 112 or 114, opposite the lever 120. Because the rack 126 is attached to the housing 142, and the feet 116 are attached to the housing 142, the movement created by the gear 132 on the rack 126 results in the feet 116 moving.

As suggested above, the gear 132 of the first leveler 112 and the second leveler 114 may be connected together via the connecting rod 134. In one approach the connecting rod 134 includes a direct connection to the two gears 132. As described above with reference to FIG. 4, the rack 126 of the first leveler 112 and the rack 126 of the second leveler 114 are disposed on opposite sides, for instance, if the rack 126 of the first leveler 112 is on a front side of the first leveler 112, the rack 126 of the second leveler 114 is disposed on the back side of the second leveler 114. In this way, the direct connection results in inverse motion of the gears 132, i.e., as one gear 132 rotates in a first direction on the rack 126, such as counterclockwise, extending one foot 116, the other gear 132 rotates in a second direction on the rack 126, such as clockwise, retracting the other foot 116. When used on uneven ground, the ladder 100 is typically lifted off the ground, such that the feet 116 extend and/or retract until contact is made with each foot 116 on the ground. Once the feet 116 are in contact with the ground, the weight of the ladder 100 can be released or placed back down on the ground, resulting in the gear lock 130 contacting the gear 132, inhibiting further motion thereof, and resulting in a second locked state. The above process can be completed all while the levers 120 are in the closed position. In addition, the system may be unlocked by having a user lift upward on the ladder 100, thereby lifting the weight of the ladder 100 off the feet. This is considered a macro-leveling adjustment.

For additional fine leveling, a second leveling aspect or step may be employed, such as where the first leveling does not provide sufficient leveling, or additional leveling is needed due environmental factors or other circumstances, such as when the ladder 100 settles into soft ground. For the second leveling step, the levers 120 are adjusted, or moved to the open position. This creates a second unlocked state. As noted above, the lever 120 being moved creates a movement of the shaft 122 which in turn biases the spring 128 and accompanying bracket to bias the gear 132 from the gear lock 130. In one illustrative embodiment, the movement of the lever 120 results in a downward movement of the shaft 122. With the gear 132 being unlocked from the gear lock 130, the gear 132 is then permitted to move on the rack 126, and in turn, move the feet 116 to provide the additional leveling.

In the second unlocked state, the ladder 100 can be titled such that an angular displacement about a base of the ladder 100, i.e., where the feet 116 contact the ground, is created. This tilting, or angular/horizontal movement of a top of the ladder 100 allows for the additional leveling and can be done without the user having to support the weight of the ladder 100. Once the ladder 100 is sufficiently leveled, the lever 120 can be moved to the closed position, resulting in the weight of the ladder 100 moving the gear 132 into the gear lock 130 and creating a second locked state, and inhibiting the gear 132 from rotating on the rack 126. This is considered a fine or micro-leveling adjustment.

In instances where the lever 120 is left in the opened position, and in turn, an unlocked state, the spring 124 may be used as a safety override. In this way, if the lever 120 is left in the open position, and weight, such as a user stepping, is applied to at least one of the plurality of rungs 106, the safety spring 124 will overcome the force of the spring 128 and allow the gear lock 130 to lock the gear 132.

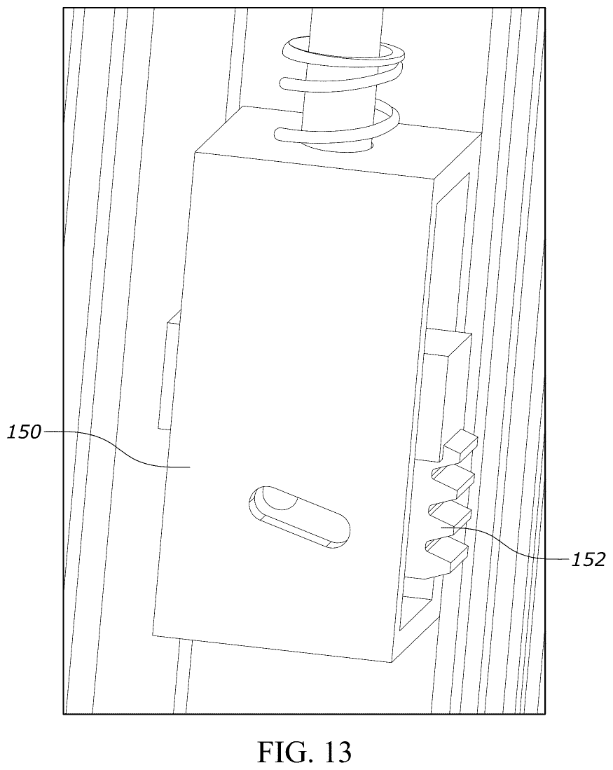

Referring to FIGS. 12 and 13, a locking mechanism 150 is shown. The locking mechanism 150 differs from the locking mechanism 140 described above in that the locking mechanism 150 prohibits movement of the first leveler 112 and the second leveler 114 through a flat gear 152 (FIG. 13) contacting the rack 126. In contrast, the locking mechanism 140 prohibits movement of the first leveler 112 and the second leveler 114 through the gear lock 130 contacting the gear 132. The locking mechanism 150 pushes the flat gear 152 onto the rack 126 when a weight is placed onto at least one rung of the plurality of rungs 106. The flat gear 152 may be locked onto the rack 126 via movement of the shaft 122 when weight is applied to one of the rungs of the plurality of rungs 106. Additionally, or alternatively, the locking mechanism 150 may be coupled to one of the plurality of rungs 106 through an opening in the housing 142, such that the downward force on the rung forces the flat gear 152 to lock onto the rack 126. In these embodiments, the gear 132 and connecting rod 134 may be utilized to extend and retract the feet 116 while leveling.

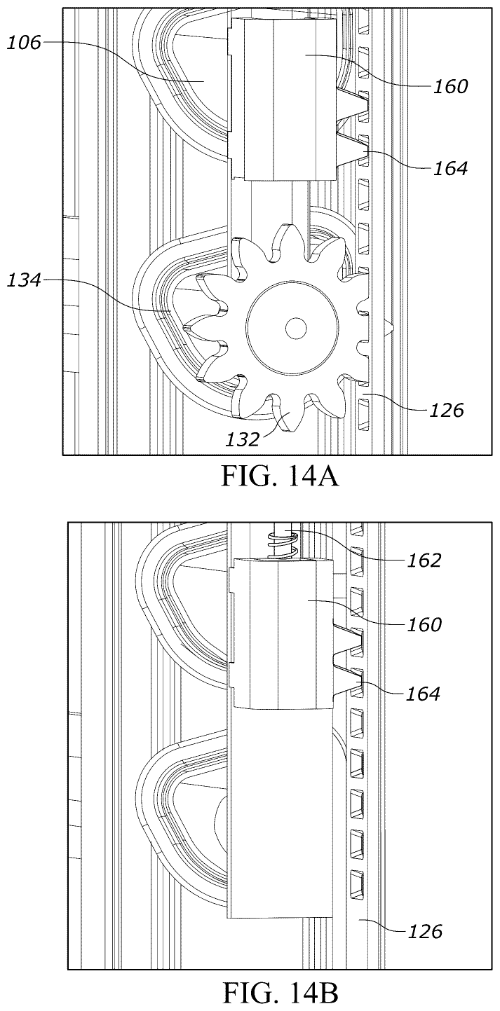

In yet further embodiments, referring to FIGS. 14A and 14B, a locking mechanism 160 is shown. The locking mechanism 160, similar to the locking mechanism 150 locks a flat gear 164 onto the rail 126. The locking mechanism 160 includes a spring 162, and in some embodiments a torsion spring. The flat gear 162 may be coupled directly to one of the plurality of rungs 106 such that the downward movement caused when a weight is applied to the rung causes the spring 162 bias the locking mechanism 160 to engage the rack 126 and lock the first leveler 112 and the second leveler 114. Similar to the locking mechanism 150, the gear 132 and connecting rod 134 may be utilized to extend and retract the feet 116 while leveling.

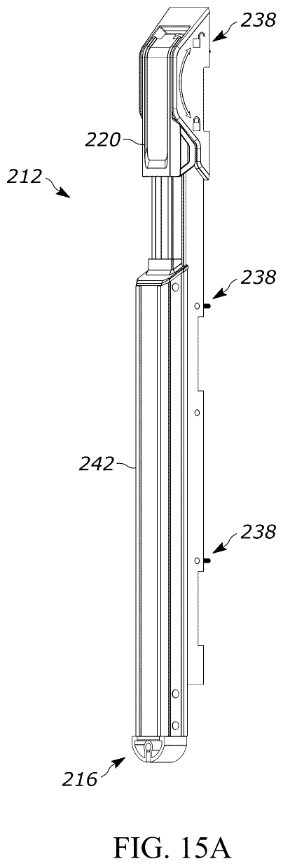

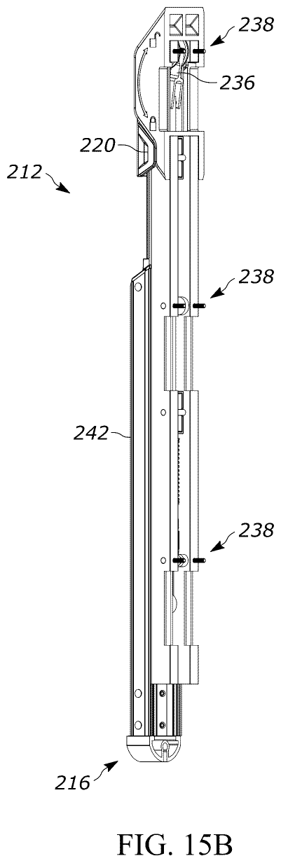

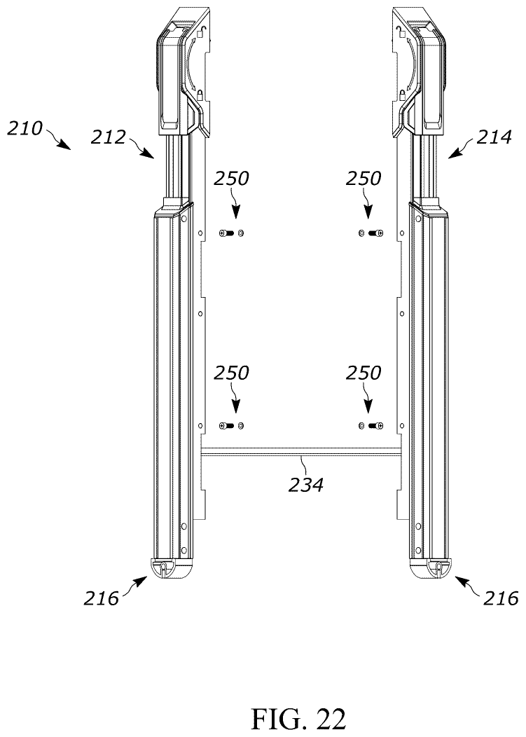

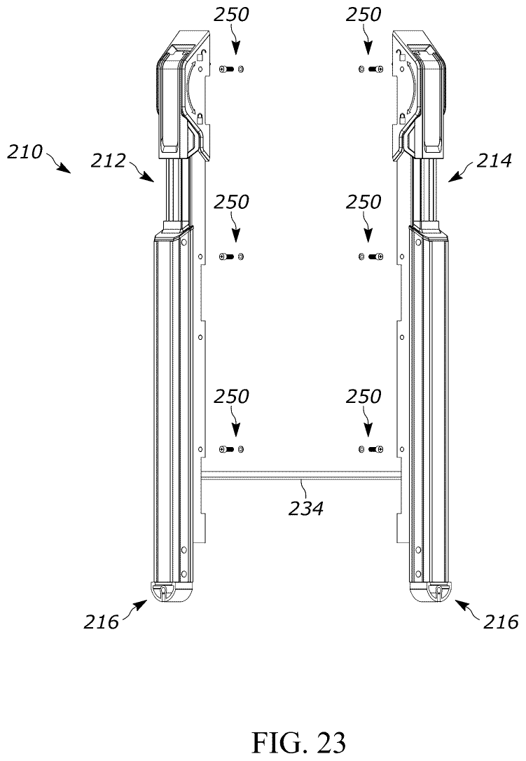

FIGS. 15A and 15B illustrate a leveling attachment, mechanism, or leveler 212 that may be employed in a leveling system 210 (see also FIGS. 22 and 23). The leveling mechanism 212, which is similar to the above described first leveling mechanism or first leveler 112 and second leveling mechanism or second leveler 114, can be attached to various kinds of climbing apparatus including ladders, such as extension, step, multi-position, and platform, as well as work platforms. In this way, the leveling mechanism 212 (along with a corresponding second leveling mechanism 214) can be retro-fitted onto existing, previously manufactured ladders and work platforms. In this manner, a user may avoid purchasing a new ladder that incorporates a leveling feature. In one illustrative configuration, the leveling system 210 includes a securement mechanism similar to the securement mechanism 238 described above, which may be used to couple portions of the leveling system 210 to one or more legs of the ladder or work platform.

In retrofit configurations, a variety of solutions for the feet may be employed. In one approach, the feet previously secured to the ladder or work platform may be utilized with the leveling system 210. In this manner, the leveling system 210 may not include new feet to be used therewith or may be included and a user may not elect to secure them to the ladder with a remainder of the leveling system 210. Alternatively, feet 216 may be incorporated into a kit with the leveling system 210, such that they may replace the feet previously coupled to the ladder or work platform.

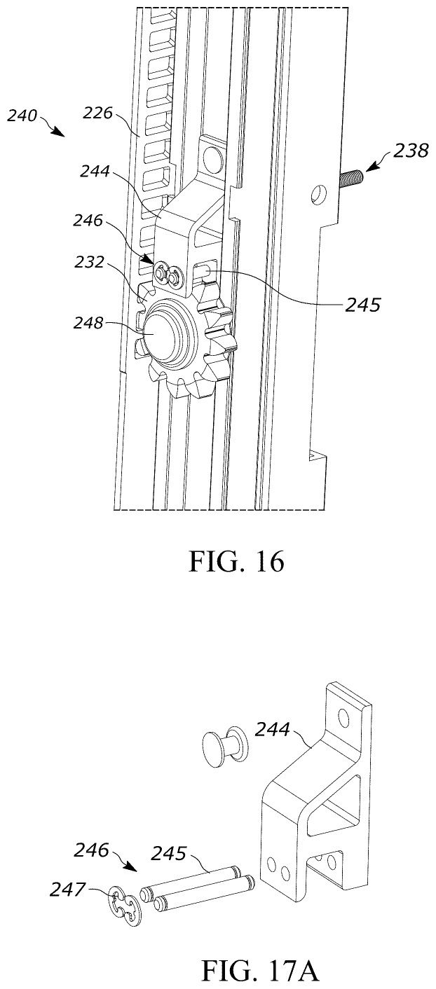

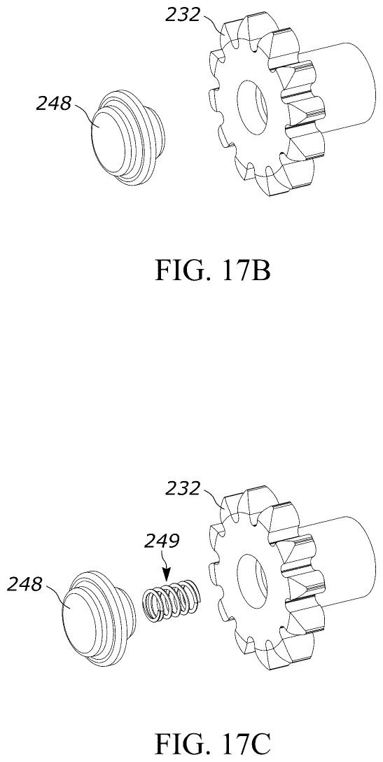

As noted above, the leveling system 210 may include securement mechanisms 238 to couple portions of the system to the ladder. In some configurations, the securement mechanism 238 may align or leverage previously formed openings or holes in the rails of the ladders or work platforms. In other configurations, a user may need to drill or form openings in the rails of the ladder to couple the leveling system to the ladder. As suggested above, in some configurations, the leveling system 210 including the first and second levelers 212, 214 may be sold with a retrofit kit with instructions on drilling new openings for the securement mechanism 238 to be retro-fitted onto a previously manufactured ladder or work platform. FIGS. 22 and 23 illustrates the kit or leveling system 210 that may be retrofit onto the FIG. 16 illustrates a locking and adjustment mechanism 240 that adjusts and secures portions of the leveling mechanisms 212, 214 relative to one another. The adjustment mechanism 240 includes a gear lock 244. The gear lock 244 is attached to the shaft 222 via a fastener, such as a rivet. The gear lock 244 can be made of bent sheet metal or extruded aluminum, among others. In some configurations, the material for the gear lock is selected to optimize or improve manufacturing efficiency and reduce production cost. As can be seen by FIGS. 17A and 17B, the gear lock 244 is typically sized and shaped to allow the gear 132 to fit in the opening of the gear lock 144.

In some configurations, the gear lock 244 includes a pin lock assembly 246. By some approaches, the pin lock assembly 246 includes one or more pins 245 and one or more links 247. The pins 245 are positioned through the pin lock assembly 246 and held in place by links 247 on each side of the gear lock 244. Additionally, the links 247 (FIG. 17A) may further couple the gear lock 244 to a portion of the housing 242. The pins 245 typically extend through the gear lock 244 and into at least a portion of the housing 242 including links 247 on the front, as shown in FIG. 16. Further, the pins may extend onto the back thereof such that the pins 245 extend through the housing 242. In some embodiments the gear lock 244 includes at least two pins configured to fit onto or about or between the gear 232.

Referring to FIGS. 17A to 17C, the adjustment mechanism 240 also includes a cap 248, and in some embodiments, a spring 249 associated with the gear 232. The cap 248, individually or in conjunction with the spring 249, may be utilized to provide a consistent force or pressure on the gear 232. In operation, this force keeps the gear 232 in place along the rails, along the connecting rod 234. In this way, the cap 148 and the spring 249 help avoid binding of the gear 232 on the rack 226, thereby making the leveling system 210 easier for a user to manipulate. In the embodiments utilizing the spring 249, the biasing force provided by the spring 249 biases the gear 232 to limit or prohibit the gear 232 from unintentionally rotating or angling within the housing 242 which may cause binding of the gear 232 on the rack 226, and in particular, binding of the teeth of the gear 232 on the rack 226. Additionally, by providing a cap 248 and spring 249 on each leveler with the biasing force which extends substantially parallel to the connecting rod 234. In this way, the biasing force from the second side helps keep the gear on the first side in the proper position and orientation to avoid binding.

For example, the cap 248 and spring 249 on the leveling mechanism 212 provides an inward biasing force on the associated gear 232 of the leveling mechanism 212. Similarly, the cap 248 and the spring 249 on the second leveling mechanism 214 also provides an inward biasing force on the associated gear 232 of the leveling mechanism 212. Accordingly, in such a configuration, the biasing forces are directed toward one another. Further, both of these biasing forces are generally along substantially the same axis, which is in fact, substantially along the axis of the connecting rod 234. As the cap 248 and the spring 249 of the leveling mechanism 212 are biasing the associated gear 232 inward, the connecting rod 234, by way of the cap 248 and the spring 249 of the corresponding second leveling mechanism 214, is biasing the gear 232 of the leveling mechanism 212 in the opposite direction, keeping the gear 232 of the leveling mechanism 212 in a proper position, and in turn, reducing the likelihood of binding the gear 232 on the rack 226.

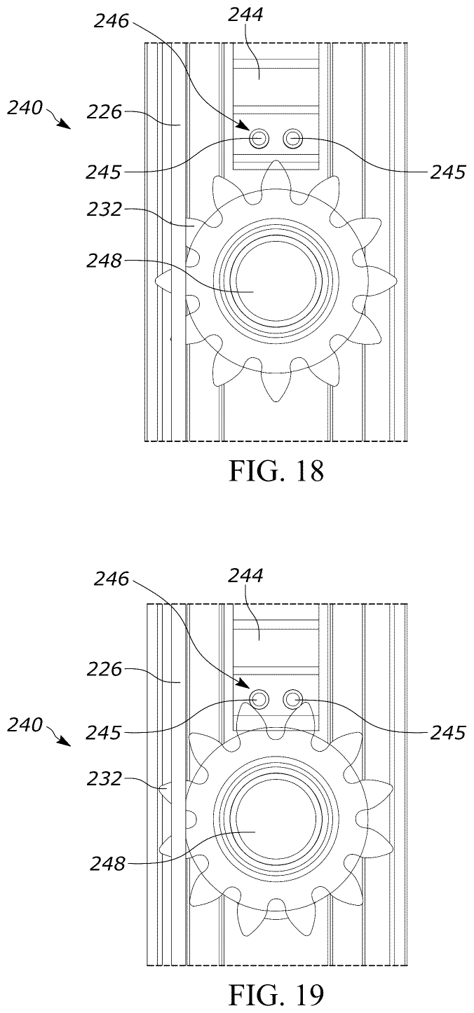

FIG. 18 illustrates an embodiment of the locking and adjustment mechanism 240 of the leveling system 210 in an unlocked position. This is illustrated by the securement mechanism of the gear lock 244 not being in contact with the gear 232. Specifically, there is a space disposed between the end of the gear teeth of the gear 232 and the pins 245 of the gear lock 244 such that the gear 232 may rotate without contacting the pins 245. When in the unlocked position or state, the gear 232 is permitted to rotate on or advance along the rack 226.

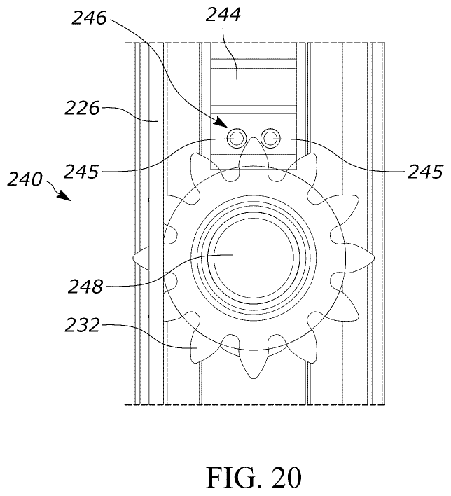

Conversely, as shown in FIGS. 19 and 20, the locking and adjustment mechanism 240 of the leveling attachments 210 is in various locked positions or states. This is illustrated by the pins 245 of the gear lock 244 contacting portions of the gear 132 (e.g., the gear teeth). FIGS. 18 to 20 illustrate the gear lock 244 interacting with the gear 232 in various configurations. It is noted, in these figures, the links 247 are removed for clarity, however, the pins 245 may include protrusions, such as bumps and the like, to keep the pins 245 securely within the gear lock 244. In addition, the referenced locked and unlocked position or state here are the similar as those described above with reference to FIGS. 9 to 11.

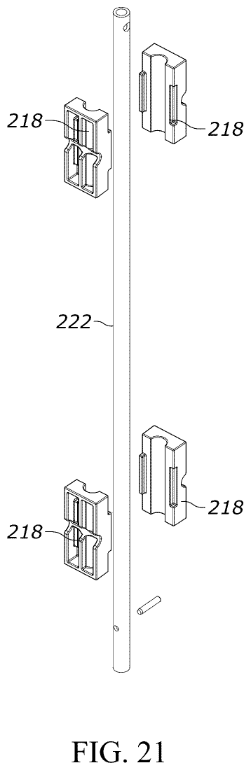

Referring to FIG. 21, in some embodiments, to further reduce binding or displacement of components within the leveling system 210, bushings 218 may be disposed within the housing 242. The bushings 218 may be used to guide or secure the shaft 222 in placed such that the shaft 222 travels in a generally consistent and substantially linear path down the housing 242 while the lever 220 is being lifted and pressed downward. Beyond providing a consistent and unimpeded path for the shaft 222 to travel, the bushings 218 may aid in avoiding the risk of binding the gear lock 244 on the gear 232.

Referring to FIG. 22, the various leveling systems and mechanisms (including the leveling system 210) described herein are applicable to climbing products, ladders, work platforms, and the like. As suggested above, these can be sold as a separate kid or come incorporated into a preassembled ladder. FIG. 22 illustrates one such leveling system 210 that may be sold separately as a kit for incorporation onto a ladder. The kit may include the leveling attachments 210, and in particular the first leveler 212 and second leveler 214 including the connecting rod 234, as shown in FIG. 22. As suggested above, the leveling system 210 may utilize the feet 216 from the existing climbing product or work platform or may be utilized with the new feet (such as those shown in FIG. 3 or FIG. 22). Further, the leveling system 210 may include nuts and bolts 250 to couple the leveling system 210 to a ladder. The nuts and bolts 250 may be used in place of the securement mechanism 238 and/or with the securement mechanism 238 to couple the leveling system 210 to a ladder. While FIG. 22 illustrates the kit having two fastening mechanisms on each side of the ladder, FIG. 23 illustrates the kit having three fastening mechanisms 250 on each ladder rail.

While the leveling system 210 is described above as a kit or retrofitted system, the previous description regarding FIGS. 1 to 14B, include the use of similar reference numerals, i.e., gear 132. FIGS. 15A to 22 use a similar numbering using a “2” as the prefix number. It should be understood that the description between components having a different prefix number apply to both components. For example, the lever 120 may be substantially the same of similar to the lever 220, accordingly, any description of the lever 120 also applies to the lever 220, and vice versa.

In use with a climbing product or work platform having four total rails, two on each side, the processes described above for leveling a ladder, such as an extension ladder having two rails, can be done and repeated on the second side, i.e., the third and fourth rail. However, in some instances, only two leveling attachments 110, 210 may be needed to level the four total rails. In this way, the leveling attachments 110, 210 can be utilized to level the climbing products or work platforms on significant slopes, such as hills or stairs.

Those skilled in the art will recognize that a wide variety of modifications, alterations, and combinations can be made with respect to the above-described embodiments without departing from the scope of the disclosure, and that such modifications, alterations, and combinations are to be viewed as being within the ambit of the disclosed concept.

1. A leveler mechanism comprising:
a first leg assembly and a second leg assembly, the first leg assembly and the second leg assembly each including a lever, a shaft movable by adjustment of the lever, a locking mechanism coupled to an end of the shaft, the locking mechanism including a gear lock, a rotatable gear, and a rack to interact with teeth of the rotatable gear;
a connecting rod coupling the first leg assembly and the second leg assembly, the connecting rod configured to extend through a rung of a ladder, and configured to rotate the rotatable gear on the rack when in an unlocked state causing inverse motion of the first leg assembly relative the second leg assembly,
wherein adjusting the locking mechanism to the unlocked state includes lifting the lever to dispose it generally orthogonal to a first rail and a second rail of the ladder, which lowers the shaft and disengages the teeth of the rotatable gear from the gear lock thereby permitting the rotatable gear to rotate along the rack, and adjusting the locking mechanism to a locked state includes lowering the lever which raises the shaft and the teeth of the rotatable gear onto the gear lock inhibiting the rotatable gear from rotating on the rack.

2. The leveler mechanism of claim 1 wherein the first leg assembly and the second leg assembly each further comprise a housing at least partially enclosing the first leg assembly and the second leg assembly including at least one opening and a securement mechanism, wherein the securement mechanism is configured to attach the first leg assembly to the first rail of a ladder and to attach the second leg assembly to the second rail of the ladder.

3. The leveler mechanism of claim 2 wherein the securement mechanism includes at least one set of bolts configured to bolt onto the first rail and the second rail of the ladder.

4. The leveler mechanism of claim 1 wherein the first leg assembly and the second leg assembly includes at least one spring coupled near a bottom of the shaft, wherein the at least one spring allows for a weight of the ladder to provide an initial leveling.

5. (canceled)

6. (canceled)

7. The leveler mechanism of claim 1 wherein the gear lock further comprises at least two pins configured to fit onto or about at least a portion of one of the teeth of the rotatable gear.

8. The leveler mechanism of claim 7 wherein the pins are configured to fit between two of the teeth of the rotatable gear and the pins are held in place by links disposed at each end of each pin.

9. (canceled)

10. The leveler mechanism of claim 1 wherein the lever comprises an over-center lever.

11. The leveler mechanism of claim 1 further comprising a bracket attached to the shaft and the rotatable gear and wherein lifting the lever causes the bracket to move the rotatable gear from the gear lock and unlocks the locking mechanism.

12. (canceled)

13. The leveler mechanism of claim 1 wherein the connecting rod has a square cross-section.

14. The leveler mechanism of claim 1 wherein the first leg assembly and the second leg assembly includes at least one spring coupled near a top of the shaft, wherein the at least one spring allows for a user to step on the ladder when in the unlocked state to provide a safety override.

15. The leveler mechanism of claim 1 wherein the lever includes a dead-man's switch, wherein the dead-man's switch returns the lever to the locked state when the dead-man's switch is released.

16. A ladder comprising:
a first rail, a second rail, a plurality of rungs extending spaced between the first rail and the second rail;
a first leg assembly and a second leg assembly, the first leg assembly and the second leg assembly each including a lever, a shaft movable via adjustment of the lever, a locking mechanism including a gear lock, a rotatable gear, and a rack to engage with teeth of the rotatable gear;
a housing substantially enclosing the first leg assembly and the second leg assembly including at least one opening and a securement mechanism, wherein the securement mechanism is configured to attach the first leg assembly to the first rail of the ladder and to attach the second leg assembly to the second rail of the ladder;
a connecting rod coupling the first leg assembly and the second leg assembly, extending through the at least one opening in the housing and at least one of the plurality of rungs, and configured to rotate the rotatable gear on the rack when in an unlocked state or lifted state causing inverse motion of the first leg assembly relative the second leg assembly.

17. The ladder claim 16 wherein the first leg assembly and the second leg assembly include at least one spring coupled near a bottom of the shaft, wherein the spring allows for weight of the ladder to provide an initial leveling.

18. The ladder claim 16 wherein the ladder is liftable to permit a weight of at least one of the ladder or the first leg assembly and the second leg assembly to provide an initial leveling of the ladder.

19. The ladder claim 16 wherein the lever is movable to the unlocked state which raises the gear lock from engaging the teeth of the rotatable gear, permitting movement of the rotatable gear on the rack.

20. (canceled)

21. The ladder claim 16 further comprising a bracket attached to the shaft and the rotatable gear and wherein the lever comprises an over-center lever and wherein the lever is movable to cause the bracket to move the rotatable gear from the gear lock to thereby unlock the locking mechanism.

22. (canceled)

23. (canceled)

24. The ladder claim 16 wherein the connecting rod has a square cross-section.

25. A ladder including:
a first rail, a second rail, a plurality of rungs extending between the first rail and the second rail, a first leg coupled to the first rail, a second leg coupled to the second rail, and a pair of leveling mechanisms,
wherein the pair of leveling mechanisms includes a locking mechanism comprising a gear lock, a shaft coupled to the gear lock, and a lever coupled to the shaft,
wherein the pair of leveling mechanisms further includes a rotatable gear and a rack coupled to a housing of the pair of leveling mechanisms, wherein the pair of leveling mechanisms are coupled together such that movement of the rotatable gear on the rack results in movement of the first leg and the second leg.

26. The ladder of claim 25 wherein the locking mechanism further comprises a flat gear movable between a locked state and an unlocked.

27. The ladder including of claim 16 wherein
the first leg assembly, the second leg assembly, and the connecting rod facilitate a macro-leveling adjustment mechanism and a micro-leveling adjustment mechanism,
wherein the macro-leveling adjustment mechanism levels the ladder utilizing a weight of the ladder and a surface the ladder is placed upon, and
wherein the micro-leveling adjustment mechanism levels the ladder after the macro-leveling adjustment mechanism and utilizes a lever to unlock a rack and pinion to adjust the first rail and the second rail.

28-50. (canceled)
